(19) United States
(12) Patent Application Publication
(10) Pub. No.: US 2025/0361166 A1
(43) Pub. Date: Nov. 27, 2025

(54) Composition and Method for Municipal and Industrial Wastewater Treatment

(71) Applicant: Dyasa Ambiental, S.A. de C.V., Garcia (MX)

(72) Inventor: David Malacar Tovar, Santa Catarina (MX)

(73) Assignee: Dyasa Ambiental, S.A. de C.V., Garcia (MX)

(21) Appl. No.: 19/216,417

(22) Filed: May 22, 2025

Related U.S. Application Data
(60) Provisional application No. 63/650,647, filed on May 22, 2024.

(51) Int. Cl. C02F 9/00; C02F 1/00; C02F 1/52; C02F 1/56; C02F 1/72; C02F 101/20; C02F 101/32; C02F 103/06; C02F 103/10; C02F 103/22

(52) U.S. Cl. CPC C02F 9/00; C02F 1/004; C02F 2001/007; C02F 1/5245; C02F 1/56; C02F 1/72; C02F 2101/20; C02F 2101/322; C02F 2103/06; C02F 2103/10; C02F 2103/22; C02F 2305/023

(57) ABSTRACT

A method for municipal and industrial wastewater treatment makes use of polymetallic salts on their own, or in conjunction with coagulating and/or flocculant agents, and/or other chemical agents for the separation of both organic and inorganic pollutants present in water. The method of treatment has three stages (chemical reaction, clarification, and filtration) and comprise the steps of receiving wastewater to be treated from a wastewater source into a reaction tank and dosing the wastewater received with reagents within the reaction tank. The wastewater received, and reagents are agitated to facilitate a reaction within a predetermined period of time. The wastewater and reagents are then transferred to a precipitation tank where any precipitation formed separates out of solution and is disposed. Once the precipitation is removed, the wastewater is transferred to a sedimentation tank and optionally filtered. The treated wastewater is stored in a storage tank until ready to be used.

### CROSS-REFERENCES TO RELATED APPLICATIONS

This original non-provisional patent application claims priority to and the benefit of U.S. Provisional Patent Application No. 63/650,647, filed May 22, 2024, entitled “Composition and Method for Municipal and Industrial Wastewater Treatment,” which is incorporated by reference herein.

### STATEMENT REGARDING FEDERALLY SPONSORED RESEARCH OR DEVELOPMENT

Not applicable.

### BACKGROUND

### 1. Field of the Invention

The present invention relates to a process for the treatment of wastewater with the use of polymetallic salt mixtures (PMSM) either by themselves or in conjunction with coagulating and/or flocculant agents and/or other chemical agents to remove organic and/or inorganic pollutants present in either solid or dissolved forms. The treatment can be followed by a filtration process, which can also be enhanced by the use of polymetallic salt mixtures.

### 2. Description of Related Art

One of the most precious and limited resources on the planet is water. Water is the essence of all life. Yet, this precious resource is a limited resource. Despite this, urban-industrial growth, overexploitation, and pollution have increased and continue to increase exponentially and contribute to the contamination of this precious resource. Untreated or undertreated wastewater not only threatens people's health, but pollutes clean water sources, rivers, and seas.

Faced with more recurrent water supply crisis/droughts, the industrial sector has the need and obligation to make better use and reuse of water, fulfilling a function of social and environmental responsibility.

Conventional treatments used so far for the treatment of wastewater include physicochemical treatments, biological treatments, and reverse osmosis, some of which have been disclosed in prior patents and a published patent application, that include U.S. Pat. No. 10,934,189 B2 (physicochemical), U.S. Pat. No. 10,479,710 B2 (biological), and U.S. Pat. Publ.No. 2011/0062079 A1 (reverse osmosis), each of which are incorporated by reference herein.

In response to this water crisis, the inventor developed the polymetallic salt mixture (PMSM) that serves as a foundation for the later developed methodology of the present invention for the treatment of contaminated water. Since the innovative and sustainable treatment system of the present invention is based on molecular affectations, the present invention replaces and/or complements the conventional treatments used so far for the treatment of wastewater.

The present invention (PMSM technology) allows for the modification of a water molecule, taking the water molecule to an ionic state that gives the water molecule unique properties, magnifying the properties of each product where the present invention is used.

The inventor found that when a water molecule becomes ionized, certain changes may be observed. For example, with the ionization of water, one of the many changes observed is that the surface modification of materials such as silica sand and activated carbon is achieved, so that these materials (e.g., silica sand and activated carbon) can be used as salt exchange agents, a situation that is not possible with conventional technologies.

Another of the changes obtained is that the same polluting material is stimulated in such a way that the polluting material can be used as a flocculant agent, recycling the polluting material, and reducing the generation of sludge.

The general formula for PMSM of the present invention is as follows:

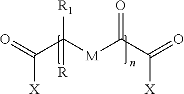

wherein n corresponds to a value between 2 and 50; M may be from the family of alkaline earth metals, transition metals or post-transition metals, R may be families of carboxyl groups; and R1 may be families of alkenes.

PMSM may be used in a variety of ways to remove contaminants. For example, PMSM may be mixed with flocculants and coagulants, among others.

PMSM may be mixed with natural flocculants, such as plant derivatives like starch, Moringa oleifera seed, plantago ovata seed, cassia obtusifolia seed, and surjana seed, among others. PMSM may also be mixed with chemical-based flocculants, such as polyacrylamide, acrylamide copolymers, polynatriumacrylate, and N, N-dimethylaminopropyleneeacrylate, among others. The flocculants may be anionic, cationic, or non-ionic with different charge density (low, medium, high) and different molecular weights (low, medium, high), among others.

PMSM may also be mixed together with inorganic coagulants, such as iron salts, magnesium salts or aluminum salts, hydroxides, and carboxylates, among others and/or organic coagulants such as polyamines, Polydiallyldimethylammonium chloride (polyDADMAC), and polythionates, among others, to achieve the removal of contaminants.

Furthermore, the polymetallic salt mixtures (PMSM) also work in conjunction with pH adjusters, such as sulfuric acid, hydrochloric acid, calcium hydroxide, and sodium hydroxide, among others.

Likewise, for the disinfection stage, the polymetallic salt mixtures (PMSM) may work in conjunction with ozone, chlorine, sodium hypochlorite, and hydrogen peroxide, among others.

### Advantages vs. Conventional Treatments

The polymetallic salt mixtures (PMSM) of the present invention have the following differentiating aspects with respect to conventional technologies:

80% of contaminants are removed within 0.1 to 10 hours, and preferably within 1 to 10 minutes.

Effective for Suspended solids, salts, and dissolved gases.

Complex and/or organic compounds such as aromatics (e.g., benzene, phenol, etc.) are transformed via chemical reaction into simpler compounds and/or are totally degraded.

Heavy metals are precipitated in the form of inactive salts.

Residual sludge, by its nature, is considered non-hazardous.

Sludge formation is reduced by up to 80% (e.g., 0.9%-6.5%) as compared to 10% to 30% of conventional systems in activated sludge treatments.

The use of polymetallic salt mixtures (PMSM) implies a carbon footprint reduction.

Conventional chemicals used in the clarification and dewatering of sludge are enhanced using PMSM. That is to say, that PMSM augments the chemical properties of conventional products by increasing their reaction efficiency and/or decreasing their consumption.

### BRIEF SUMMARY OF THE INVENTION

The chemical treatment technology of the present invention provides ionization to the water molecule to achieve the release of pollutants.

It consists of a process that works chemically by ionizing water molecules, transforming residues, and physically separating them to produce clean, reusable water.

The water molecule is ionized, producing a super-oxidation effect. Magnetic fields in water are induced through a chemical process of the PMSM in a controlled manner. The ionization process is done in a self-ionization reaction.

Ionization is achieved through a reinforcement in hydrogen bonds. The process is conducted based on molecular affectations. The water molecules are excited, altering the structure of hydrogen bonds and taking advantage of the interaction that reinforces this modification. The result is a characteristic of the interactions between the water molecules, as well as with the substances present in the water. The affectation of the water molecule is driven through the nature of its atoms: hydrogen and oxygen; wherein, the oxygen atom of the water molecule attracts the electrons of the covalent bonds with the hydrogens. The difference in energy between the covalent bonds is used, causing the water molecules to renew their structure, which makes intermolecular renewal considerably strong.

This process generates highly reactive free radicals such as hydroxyls, which attack contaminants via oxidation, causing degradation of the contaminants.

Pollutants are transformed into simpler compounds, precipitating in inactive form as non-hazardous residues.

### BRIEF DESCRIPTION OF THE FIGURES

FIG. 1 depicts a front perspective of the various components of an embodiment of the present invention.

FIG. 2. is an upper view of a mobile wastewater treatment plant involving a fracking water sample, showing the different stages of treatment, and illustrating the effectiveness of the present invention in the samples.

FIG. 3 is a front view of hydrocarbon samples at various stages of treatment, illustrating the effectiveness of the present invention in the samples.

FIG. 4 is a front view of hydrocarbon samples at various stages of treatment, illustrating the effectiveness of the present invention in the samples.

FIG. 5 is a front view of garbage water samples (leachates) at various stages of treatment, illustrating the effectiveness of the present invention in the samples.

FIG. 6 is a front view of sanitary water samples at various stages of treatment, illustrating the effectiveness of the present invention in the samples.

FIG. 7 is a front view of animal processing water (slaughterhouse wastewater) samples at various stages of treatment, illustrating the effectiveness of the present invention in the samples.

FIG. 8 is a front view of automobile industry wastewater samples at various stages of treatment, illustrating the effectiveness of the present invention in the samples.

FIG. 9 is a front view of mining wastewater sample before and after the application of PMSM technology, illustrating the effectiveness of the present invention in the samples.

### DETAILED DESCRIPTION OF THE INVENTION

The PMSM technology of the present invention consists of three stages which include chemical reaction, clarification, and filtration. Each of these stages are discussed in more detail below.

### 1. Chemical Reaction

The first step or stage is that the PMSM of the present invention chemically reacts with the pollutants in the water to be treated. Through the chemical process of the present invention, a molecular excitation is achieved that releases the energy contained within the water itself. This way, it is possible to separate the pollutants and degrade them at the molecular level, forming simple and inert components.

### 2. Clarification

The next step or stage of the present invention is clarification. During this process, any sludge that is suspended and dissolved in the water continues separating, settling, achieving water clarification and decreasing the solids present, with a minimum amount of coagulants and flocculants.

### 3. Filtration

After the previous two steps, the next step or stage is filtration. Upon the method of the present invention achieving its objective, filters can be used to improve the quality of the water obtained. The water finishes the process by passing through a zeolite battery and activated carbon filters. These filter batteries are, in turn, treated with PMSM, which increases the life and efficiency of the filters, thus obtaining an excellent quality of treated water. The color and odor are removed in conjunction with the latest contaminants present in the water. The filtration stage may or may not be required depending on the desired output specifications.

The treatment of the filters with PMSM increases the life/efficiency of the filters in two ways. First, the PMSM takes advantage of the available electrons that are in the filter media. This generates an ionic lattice which more efficiently traps the solids and/or contaminants that are still present in the water. At the same time, when backwashing or cleaning the filters, it is easier to remove what has been retained in the filter. Second, the water thus far treated is cleaner, thereby having less particles that need to be removed.

By using zeolite and activated carbon filters, pre-treated with PMSM, the life and efficiency of the filters is increased, ensuring better and more cost-effective results from treated water. Filtration ends with the removal of the smallest solids to ensure the highest possible water clarity.

### Procedure:

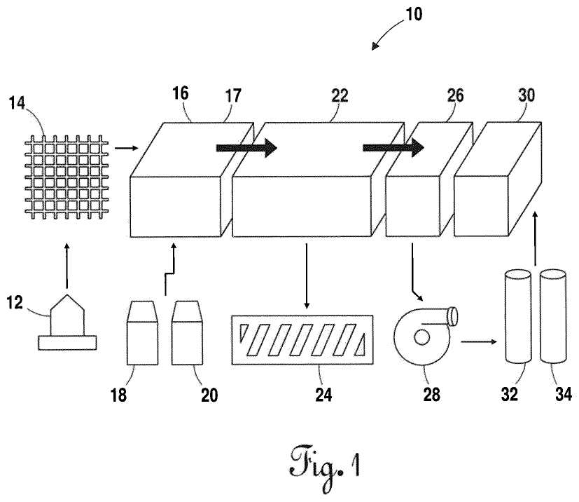

Referring now to FIG. 1, a wastewater treatment plant (WWTP) based on polymetallic salt mixtures (PMSM) (wastewater treatment system 10) is comprised of five (5) tanks and a filtration system, which are described below.
1. Reaction tank: Raw untreated wastewater is pumped from treatment plant 12 through screen 14 into reaction tank 16. Screen 14 removes any large particles that may be present in the wastewater to be treated. Reaction tank 16 receives the now screened wastewater to be treated. Application of the dosing of the reagents with chemical dispensers/dosing pumps 18 and 20 occurs within reaction tank 16. Dosing pumps 18 and 20 were previously calibrated according to a defined flow and the pollutants present in the untreated wastewater. This flow can range from 0.1 gal./min. to 250 gal./min. In addition, agitation occurs for an amount of time sufficient to promote an optimal chemical reaction of the aggregated products together with the influent. The optimal chemical reaction obtained is an 80% reaction as compared to traditional technologies, e.g., physicochemical treatment.
2. Precipitation tank: Precipitation tank 17 is integrated within reaction tank 16. Once the reactions between the aggregated products and the influent are complete, the remaining 20% of sludge reaction and separation is conducted in precipitation tank 17.
3. Sedimentation tank: Still referring to FIG. 1., once the chemical reactions and any precipitation have taken place in in reaction tank 16 and precipitation tank 17, the wastewater then moves into sedimentation tank 22. A “lamellar” type sedimentation is conducted within sedimentation tank 22 to separate small particles suspended in the water being treated, complying with a hydraulic retention time (discussed below) throughout the treatment. The resulting sludge or sedimentation collected is disposed of via sludge disposal 24 within sedimentation tank 22. At this point of the treatment, much of the original sludge that may have been originally contained in the wastewater to be treated has been removed.
4. Pre-filtered water tank: Once the sludge or sedimentation is removed, the wastewater being treated passes into pre-filter water tank or container 26. The wastewater being treated then passes into centrifugal pump 28 where the wastewater is further filtered and backwashed after being pumped to a series of filters. The filtration stage may or may not be required depending on the desired output specifications.
5. Filters battery: After being stored in the pre-filter water container 26, the wastewater being treated is pumped out via centrifugal pump 28 and passes through first one (1) zeolite sand filter 32 and then through activated mineral carbon filters 34, as shown in FIG. 1 (and in which only one carbon filter is shown). Zeolite filter 32 filters out and retains any solids that may still be present in the wastewater being treated. Activated mineral carbon filters 34 eliminate other colors, odors, etc., and improve the quality of the treated water. Zeolite sand filter 32 and activated mineral carbon filters 34 are treated with the PMSM technology of the present invention. The filtration stage may or may not be required depending on the desired output specifications.
6. Treated water tank: After passing the water through the filter battery (i.e., Zeolite sand filter 32 and activated mineral carbon filters 34), the now treated water is stored in treated water tank or container 30 to be used as desired, in accordance with its intended use. The filtration stage may or may not be required depending on the desired output specifications.

The operating process time of the water to be treated from the moment of entry to the final exit is called the hydraulic retention time. The hydraulic retention time of the present invention is from 1 to 10 hours, and preferably from 0.5 to 2 hours, depending on the feed flow and on the type of water. For example, petrochemical water contains more complex pollutants than sanitary water. This higher concentration of complex pollutants necessitates a higher dose of chemicals and, thus, petrochemical water has a longer residence time (e.g., 1 to 1 ½ hours) to degrade and separate contaminants. In contrast, sanitary water generally has simpler contaminants and requires a lower dosage of chemicals. Thus, the residence time of sanitary water is less, e.g., 30 minutes to 1 hour, to separate contaminants and degrade them.

Still referring to FIG. 1, the sludge formed in the course of the process is collected and extracted by a pumping system (i.e., centrifugal pump 28) for a definitive placement based on its disposition. In most cases, the sludge formed from the treatment process is inert does not represent any danger and can be used as fertilizer or compost if a chemical analysis of the formed sludge is satisfactory in accordance with applicable regulations.

The foregoing procedure represents the typical process scheme, though it may be modified or adapted according to each particular circumstance, which is analyzed on a case-by-case basis. Also, the polymetallic salt mixtures (PMSM) may be adapted to existing wastewater treatment plants (WWTP), resulting in a space and cost saving option.

In addition, in the operative field, the polymetallic salt mixtures (PMSM) not only may be visualized as a standalone treatment, but also as a complement to different conventional treatments to enhance and/or optimize the system and obtain the desired specific results in terms of contaminants removal. To mention some examples, enunciative but not limited to the following, the polymetallic salt mixtures (PMSM) may be applied as a complete treatment (as described in the procedure section); as a chemical roughing to attack the initial contaminant load; or as a polishing step to remove the final impurities and contaminants remaining.

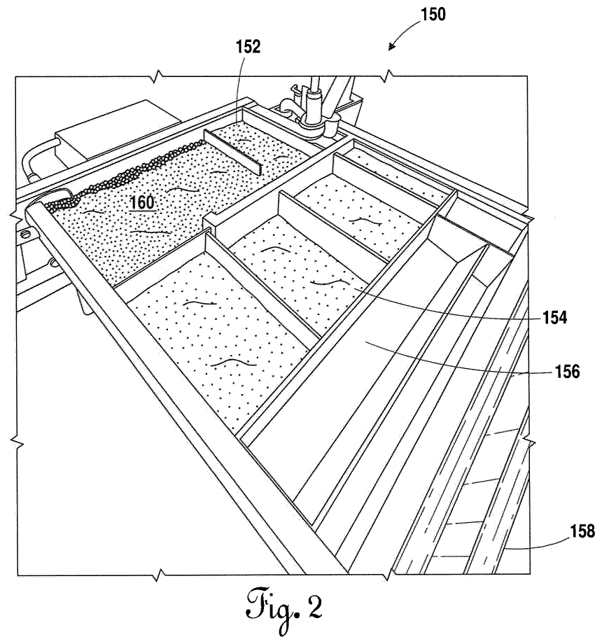

In an alternative embodiment, the present invention may also be portable. Referring now to FIG. 2, mobile wastewater treatment plant 150 is comprised of various stages, including reaction zone 152, sedimentation zone 154, prefiltration zone (pre filtered water tank 156) and treated zone (treated water tank 158).

Sample 160 to be treated is introduced to reaction zone 152 of mobile wastewater treatment plant 150. Sample 160 undergoes a treatment process (similar to the treatment processed previously discussed) wherein sample 160 moves from reaction zone 152 through sedimentation zone 154 as sample 160 is being treated. Sample 160 then passes into pre filtered water tank 156 and ultimately stored in treated water tank 158. The treatment of sample 160 with PMSM yielded a clear sample with no odor.

### Benefits of the use of Polymetallic Salt Mixtures (PMSM) in Complement With Other Systems.

### Pretreatment With the use of PMSM Prior to a Biological System

The pretreatment with the use of PMSM of the present invention prior to a biological system lowers sludge production (estimated 20%-30% lower). The pretreatment with the use of PMSM of the present invention further lowers the biological system design, doing so by reducing organic load. The reduction in organic load may be up to 30% lower than without PMSM pretreatment. PMSM pretreatment also lowers KWH consumption by reducing organic load that is sent to the biological system, with the reduction estimated at between 25% and 50% lower.

### Pretreatment With the use of PMSM Prior to Purification With Osmosis

The pretreatment with PMSM prior to purification with osmosis yields an average recovery of 80-88% compared to 50% for high silica management. An average recovery of 80-88% is estimated compared to 70% for high hardness handling. The pretreatment with PMSM prior to purification with osmosis also yields a reduction in the cost of disposal of rejected water which translates to a lower cost of chemical treatment of reverse osmosis. This is because a lower dosage of chemicals is required, given the treatment of an influent with better quality. There is also a reduction of downtime observed due to downtime for cleaning, and conversely, there is an extended period of time between cleanings observed, when pretreating with PMSM prior to purification with osmosis.

### New Plants Where PMSM can be Introduced in Addition to or Replacement With Other Technologies (Anaerobic, Aerobic Systems, etc.)

The present invention may be incorporated in new plants in addition to or in place of prior technologies (e.g., anaerobic systems, aerobic systems, etc.) through minor investments of each system (aerobic biological systems, anaerobic, osmosis, etc.), e.g., estimated 20-30% minor investment. The present invention guarantees process reliability and complies 100% of the time. In circumstances where PMSM of the present invention is incorporated or otherwise used with existing plants, such use yields plants that are more reliable and more feasible for adjustments in case of contingencies.

### Applications:

The polymetallic salt mixtures (PMSM) of the present invention provides a solution for the current problems present in different areas of application with respect to the initial water quality presented.

The polymetallic salt mixtures (PMSM) of the present invention have application in several areas, including, but not limited to, congenital waters, garbage leachate, sanitary wastewater, and slaughterhouses, industrial water, mining, among others.

For a particular application, a treatment can be designed to obtain water with behavior that significantly favors the process where such treatment is used.

The treatment method of the present invention can be applied in the following non-exhaustive areas: domestic wastewater; industrial wastewater (e.g., automotive industry, pulp and paper industry, metal-mechanic industry, food and beverage industry, textile industry, among others); petrochemistry; congenital waters; decontamination of rivers, streams, artificial or natural reservoirs; water desalination; water purification and sanitization; sludge treatment plants, generating harmless sludge for management; healthcare sector; soil bioremediation; mining; irrigation agriculture; waste treatment (leachate); treatment of tequila by-products and sugar industry (Vinasse); beef, pork and chicken slaughterhouses; chemical industries; streamlining reverse osmosis systems; and water contaminated with heavy metals, among others.

### Description of Applications and Examples

### Oil & Gas

The process for the treatment of wastewater of the present invention may also be used in the oil & gas industry, and more specifically, in all the processes involved, such as drilling, extraction, refining, transportation, storage, etc. All these processes involve water in a significant way which yield several different applications. The wastewater from the oil & gas industry is composed mainly of hydrocarbon waste, aromatic and aliphatic compounds highly stable, heavy metals, sulfur compounds and/or dissolved gases, among others. By way of example, and not limitation, the treatment process of the present invention effectively treats water that contains highly toxic aromatic compounds and water containing compounds such as fats and oils. The result of the treatment of the waterwater is that the highly toxic aromatic compounds and fats and oils are eliminated. These are but two examples, though there are many others contemplated by the present invention. Each particular circumstance is analyzed on a case-by-case basis.

Also, phenol is known for its toxicity and low biodegradability. The contamination of the water used in the refining of petroleum with this substance leads to a saturation in the groundwater tables surrounding the refinery as a primary phase, and the contamination can reach mantles and aquifers more than 200 km around. This falls within the laws of environmental protection which, in addition to the cost of remediation of these bodies of water, impose stiff, significant penalties for those who cause such pollution. PMSM allows the removal of phenol in water from levels of 60 ppm down to values as low as 0.04 ppm.

In addition, the present invention may also be applied in the fracking industry. The wastewater coming from the fracking industry can be contaminated with hydraulic fracturing chemicals, heavy metals, organic compounds, suspended solids and a high concentration of salts and total dissolved solids, which can include chlorides, sulfates, and other dissolved minerals, among others. The main challenges to treat this water are the variability in their contaminant's composition, its high salinity, and total dissolved solids.

### Case One

### Description

The polymetallic salt mixtures (PMSM) were applied to treat a sample of wastewater from a fracking process, which had high conductivity caused by the total dissolved solids and salts. A simple treatment with PMSM was performed on the sample (FIG. 2), following a procedure similar to the one shown in FIG. 1, resulting in a clear sample with no odor. The results are as shown in the following table:

### Results

TABLE 1
Parameters

| | | |
|---|---|---|
| Parameter | Entrance | PMSM Output |

| | | |
|---|---|---|
| pH | 7.18 | 7.84 |

| TDS | 119,830 | mg/L | 2,518 | mg/L |
|---|---|---|---|---|
| Hardness (CaCO3) | 10,860 | mg/L | 295 | mg/L |
| Conductivity | 150,243 | uS/cm | 4,902 | uS/cm |
| Turbidity | 72 | NTU | Less than 7 NTU | |
| Calcium | 3,770 | mg/L | 104 | mg/L |
| Iron III | 1.76 | mg/L | 0.11 | mg/L |
| Magnesium | 350 | mg/L | 8.4 | mg/L |
| Sodium | 40,200 | mg/L | 646 | mg/L |
| Chloride | 71,650 | mg/L | Less than 1400 mg/L | |
| Sulfate | 500 | mg/L | 67 | mg/L |

### Case Two

### Description.

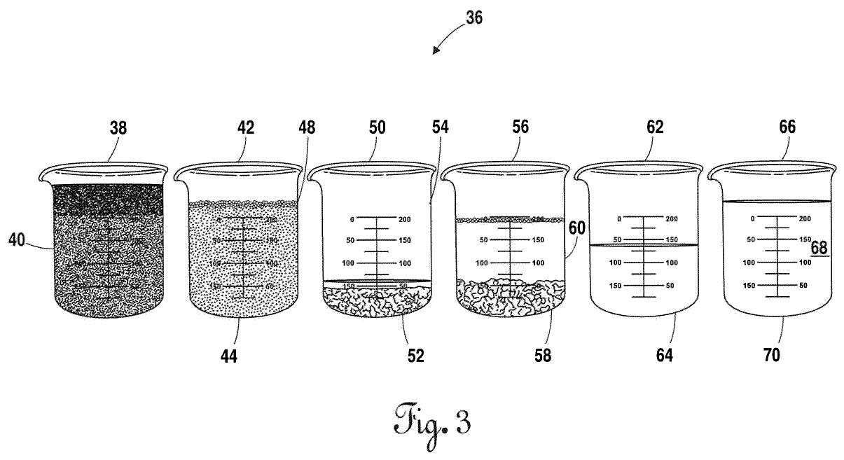

Turning now to FIG. 3, an array of samples 36 contains several containers, including containers 38, 42, 50, 56, 62, and 66. These containers show the treatment process in various stages of case one. Beginning with container 38, original raw wastewater sample 40 includes water contaminated with hydrocarbons. Sample 40 had a turbid black coloration with oils on the surface and a hydrocarbon odor. The containers used in the present invention were graduated glass beakers. However, other scientific equipment and glassware, such as Erlenmeyer flasks and the like, may be used as still remain within the contemplation of the present invention.

Two procedures were performed on sample 40. The first was removing as much of the oils as possible. The second was a treatment with PMSM (not shown). This resulted in sample 44 shown in container 42. Sample 44 separated into clear layer 46 and a thin top oil layer 48 with a slight odor. Subsequent treatment shows the results in container 50 with solids 52 precipitating out of solution and a clear layer 54 above. The next stage similarly shows continued separation in container 56 with more solid 58 precipitating out with clear layer 60 above. In container 62, no discernible separation is observed, the sample 64 comprising entirely of a clear liquid. Finally, container 66 shows an even more colorless portion 68 of the now treated sample 70.

### Chemicals Used.

In a 150 ml of sample, Coagulant A, PMSM, Coagulant B and Flocculant A were used. The sample was water contaminated with products or byproducts of hydrocarbons, oils, fats, and chemical compounds from petroleum. Coagulant A is ferric chloride. Coagulant B is a calcium hydroxide water blend. Flocculant A is an anionic polymer. The results are as described above and as shown in Table 1 below:

### Results

TABLE 2
Parameters

| | | |
|---|---|---|
| Parameter | Entrance | PMSM Output |

| | | |
|---|---|---|
| pH | 6 | 7.5 |

| | | | | |
|---|---|---|---|---|
| Conductivity | 2.98 | mS/cm | 2.58 | mS/cm |
| TSS | 29 | mg/l | 4 | mg/l |
| Turbidity | 35 | NTU | 6 | NTU |
| COD (**) | 850 | mg/l | 110 | mg/l |

| | | |
|---|---|---|
| Color | Black turbid. | Clear |
| Odor | Hydrocarbons. | No smell. |

** represents the parameter of chemical oxygen demand. The present invention eliminates and/or reduces dissolved and undissolved COD and biochemical oxygen demand (BOD). The parameters describe the characteristics observed with the original wastewater sample before treatment as well as after treatment.

### Case Three

### Description.

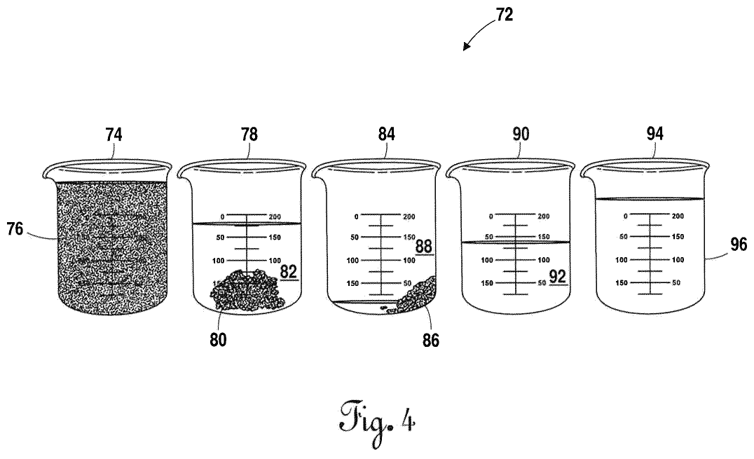

Turning now to FIG. 4, an array of samples 72 contain several containers, including containers 74, 78, 84, 90 and 94. These containers show the treatment process in various stages for case three. Beginning with container 74, the original raw wastewater sample 76 includes water contaminated with hydrocarbons. Sample 76 had a turbid black coloration with precipitating solids and an odor of hydrocarbons.

A simple treatment with PMSM (not shown) was performed, ultimately resulting in a clear odorless sample. The treatment process and results are similar to the treatment process and results described in case two. After treatment of PMSM (not shown), solids 80 from sample 76 precipitated out of solution, leaving clear layer 82 in container 78. Solids 80 concentrated to and reduced in size to solids 86 shown in container 84. Then the solids were removed, leaving just a clear layer 92 in container 90. The final treated sample 96 in container 94 was clear and odorless.

### Chemicals Used.

In a 150 ml sample, PMSM, Coagulant C and Flocculant A were used. Coagulant C is polyaluminum chloride. Flocculant A is an anionic polymer. The results were as shown in Table 2 below:

### Results

TABLE 3
Parameters

| | | |
|---|---|---|
| Parameter | Entrance | PMSM Output |

| | | |
|---|---|---|
| pH | 10 | 8 |

| | | | | |
|---|---|---|---|---|
| Conductivity | 5.54 | mS/cm | 3.42 | mS/cm |
| TSS | 641 | mg/l | 2 | mg/l |
| Turbidity | 527 | NTU | 2 | NTU |
| COD (**) | 1 601 | mg/l | 133 | mg/l |

| | | |
|---|---|---|
| Color | Black turbid | Clear |
| Odor | Hydrocarbons. | No smell. |

### Industrial Service Systems

### Osmosis

Application as a pre-treatment before the water enters osmosis.

### Waste Treatment (Leachate)

Landfill leachate refers to a mixture of the following: percolated rainwater; water resulting from the biodegradation of waste; and the inherent water in waste, which contains copious amounts of suspended solids, organic compounds, ammonia, salts and chlorides, heavy metals, among others. The use of polymetallic salt mixtures (PMSM) in leachates enables quality discharge to rivers and dams, or to be reused with human contact.

### Case Four

### Description.

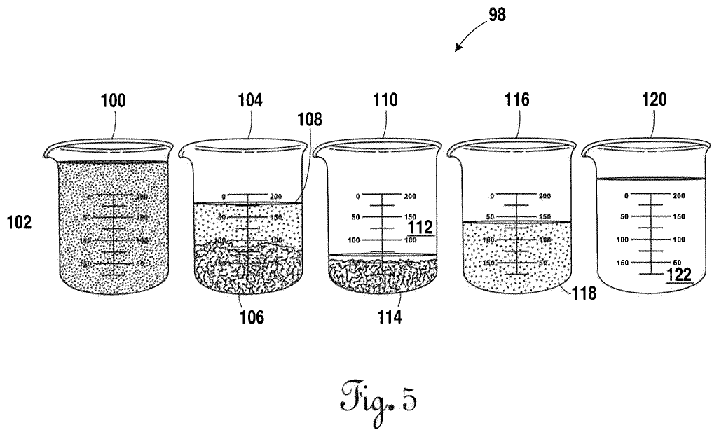

Turning now to FIG. 5, an array of samples 98 contains several containers, including containers 100, 104, 110, 116 and 120. These containers show the treatment process in various stages of case four. Beginning with container 100, original raw wastewater sample 102 includes a sample of garbage water having an orange coloration with floating particles and a strong odor of decomposing organic matter.

A simple treatment with PMSM (not shown) was performed resulting in a clear odorless sample. The treatment process and results are similar to the treatment process and results described in the prior cases. After treatment of PMSM (not shown), solids 106 from sample 102 precipitated out of solution, leaving clear but colored layer 108 in container 104. Solids 106 concentrated to and reduced in size to solids 114 shown in container 110. Then the solids were removed, leaving just a clear but colored liquid 118 in container 116. The final treated sample 122 in container 120 was clear and odorless.

### Chemicals Used.

In a 150 ml sample, PMSM, Coagulant B, Coagulant C and Flocculant A were used. Coagulant B is a calcium hydroxide water blend. Coagulant C is polyaluminum chloride. Flocculant A is an anionic polymer. The results are as shown in Table 4 below:

### Results

TABLE 4
Parameters

| | | |
|---|---|---|
| Parameter | Entrance | PMSM Output |

| | | |
|---|---|---|
| pH | 7.58 | 8.02 |

| | | | | |
|---|---|---|---|---|
| Conductivity | 16.67 | mS/cm | 12.33 | mS/cm |
| TSS | 82 | mg/l | 3 | mg/l |
| Turbidity | 158 | NTU | 4 | NTU |
| COD (**) | 1 000 | mg/l | 110 | mg/l |

| | | |
|---|---|---|
| Color | Cloudy orange. | Clear |
| Odor | Decomposing organic | No smell. |
| | matter. | |

### Sewage

The organic content of sewage water is composed primarily of synthetic detergents, fats, soaps, and lignin, carbohydrates, proteins, nutrients, and natural and synthetic chemicals from the processing industries, among others. It can also contain a variety of inorganic substances including toxic heavy metals. PMSM successfully treats low, medium, and high pollutant loads, as well as variable inflow rates present in the WWTP, in compliance with regulations.

The treatment of sewage has been characterized by consisting of primary treatment, primarily for the removal of coarse solids. A secondary treatment for the removal of biodegradable material follows, ending with a series of clarification stages.

A complete treatment can be achieved only using the primary treatment, achieving the complete removal of contaminants to comply with the official regulatory standards according to the country that applies.

Given the characteristics of technology, it is possible to convert secondary treatment facilities into a facility that incorporates the treatment process of the present invention. For example, a traditional 1000 gpm plant has a residence time of 6 hours and installed in 2000 m². Adapting this processing plant with the treatment process of the present invention, with the same area of 2000 m² the flow is tripled to 3000 gpm. This increase in flow is as a direct result of faster reaction times with the treatment process of the present invention., Consequently, the use of the present invention may be incorporated into traditional plants (either in adapting current processing plants with the present invention or building a plant with the present invention integrated from the beginning), achieving not only savings per investment, but also an increase of up to three (3) times the treatment capacity.

Another advantage is that the required installation areas are considerably smaller than those employed by traditional technology. For example, a 1 low pressure sewer system (LPSS) plant can be installed in an area as small as 35 m² or less, as required.

Odors from secondary treatment plants are not present in this type of system since they are inactivated when they come into contact with the reagents. It is, therefore, possible to install these plants at shorter distances than traditional plants. In other words, PMSM treatment plants do not emit odors due to their chemical reaction, which allows for installation of plants within neighborhoods, towns, and/or cities.

The ionization of the water molecule, modifies the behavior of solids in water, allowing them to be used as a flocculant agent.

This recycles the same pollutant and reduces waste generation.

### Case Five

### Description.

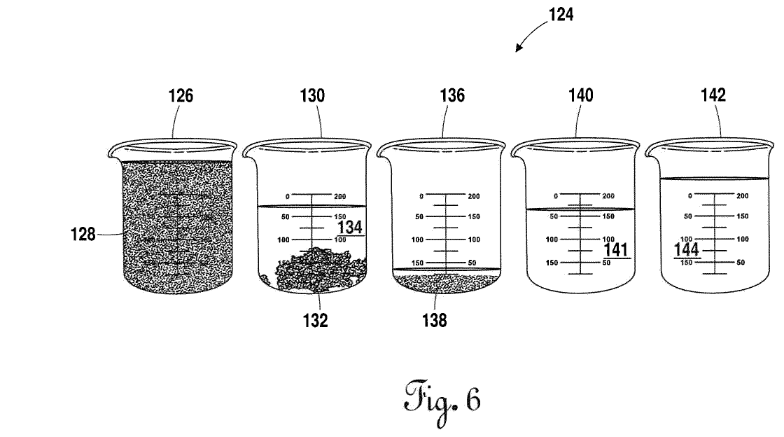

Turning now to FIG. 6, an array of samples 124 contains several containers, including containers 126, 130, 136, 140 and 142. These containers show the treatment process in various stages. Beginning with container 126, original raw wastewater sample 128 includes sanitary water. Sample 128 had a gray/dark coloration with solids in precipitation and some particles in flotation and an odor of decomposing organic matter.

A simple treatment with PMSM (not shown) was performed, the result was a clear odorless sample. The treatment process and results are similar to the treatment process and results described in the prior cases. After treatment of PMSM (not shown), solids 132 from sample 128 precipitated out of solution, leaving clear liquid layer 134 in container 130. Solids 132 concentrated to and reduced in size to solids 138 shown in container 136. Then the solids were removed, leaving just a clear liquid 141 in container 140. The final treated sample 144 in container 142 was clear, colorless, and odorless.

### Chemicals Used.

In a 150 ml sample, PMSM, Coagulant B, and Flocculant A were used. Coagulant B is a calcium hydroxide water blend. Flocculant A is an anionic polymer. The results are as shown in Table 5 below:

### Results

TABLE 5
Parameters

| | | |
|---|---|---|
| Parameter | Entrance | PMSM Output |

| | | |
|---|---|---|
| pH | 6.88 | 7.78 |

| | | | | |
|---|---|---|---|---|
| Conductivity | 1.33 | mS/cm | 1.08 | mS/cm |
| TSS | 192 | mg/l | 1 | mg/l |
| Turbidity | 181 | NTU | 2 | NTU |
| COD (**) | 1 144 | mg/l | 95 | mg/l |

| | | |
|---|---|---|
| Color | Cloudy gray. | Clear. |
| Odor | Decomposing organic | No smell. |
| | matter. | |

### Industrial Wastewater

Wastewater, depending on the generating source, can have a varied number of pollutants and concentrations, so each treatment must be tailored to the need. For example, wastewater is divided into families or groups, e.g., heterochemical type family, where all the treatments of water from crude oil extraction, refinery and/or similar are included. The inventor has found that the treatment process of the present invention is remarkably similar to each other and reproducible across diverse types of industries. For example, the same treatment may also be used as effectively for a paper industry group or a food industry group or family.

With this treatment it is possible not only to achieve an adequate quality for discharge, but also the reuse of water for processes, use in services and/or irrigation of green areas.

Whether it is the case of secondary treatment, flocculation, filtration, ultrafiltration, DAF, oil separator, PMSM can be used by making small modifications to such equipment to achieve a more efficient, and, therefore, profitable treatment, achieving savings that justify not only the conversion of a traditional plant to one that uses PMSM based treatment of the present invention or initial investment, but also savings due to environmental impact whose quantification goes beyond the economic factor.

### Food and Beverages/Slaughterhouse Industry

By way of example, and not limitation, the treatment process of food and beverages/slaughterhouse industry with the use of polymetallic salt mixtures (PMSM) effectively attacks high COD and BOD loads; attacks fats and oils (after application of a fat separator) and treats highly colored wastewater. Each particular circumstance is analyzed on a case-by-case basis.

### Case Six

### Description.

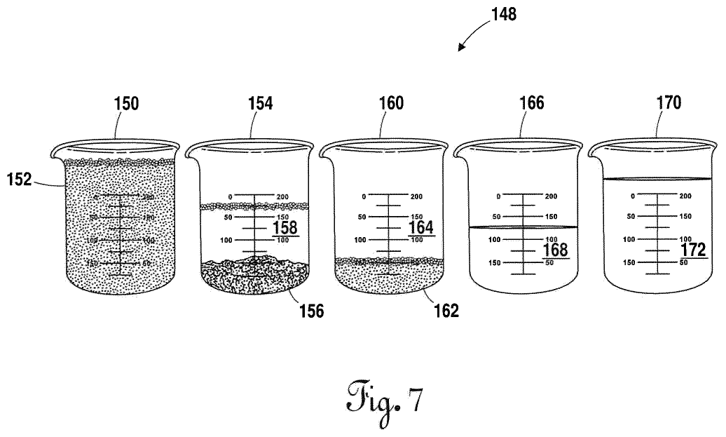

Turning now to FIG. 7, an array of samples 148 contains several containers, including containers 150, 154, 160, 166 and 170. These containers show the treatment process in various stages. Beginning with container 150, original raw wastewater sample 152 includes animal processing water (slaughterhouse wastewater). Sample 152 had a reddish coloration with some precipitating solids and a strong odor of decaying organic matter.

A simple treatment with PMSM (not shown) was performed, resulting in a clear, odorless sample. The treatment process and results are similar to the treatment process and results described in the prior cases. After treatment of PMSM (not shown), solids 156 from sample 152 precipitated out of solution, leaving clear liquid layer 158 above as seen in container 154. Solids 156 concentrated to and reduced in size to solids 162 leaving same and clear liquid layer 164 shown in container 160. Then the solids were removed, leaving just a clear liquid 168 in container 166. The final treated sample 172 in container 170 was clear and odorless.

### Chemicals Used.

In a 150 ml of sample, Coagulant A, PMSM, Coagulant B, Coagulant C and Flocculant A were used. Coagulant A is ferric chloride. Coagulant B is a calcium hydroxide water blend. Coagulant C is polyaluminum chloride. Flocculant A is an anionic polymer. The results are as shown in Table 6 below:

### Results

TABLE 6
Parameters

| | | |
|---|---|---|
| Parameter | Entrance | PMSM Output |

| | | |
|---|---|---|
| pH | 7 | 7 |

| | | | | |
|---|---|---|---|---|
| Conductivity | 2.28 | mS/cm | 1.72 | mS/cm |
| TSS | 289 | mg/l | 4 | mg/l |
| Turbidity | 372 | NTU | 6 | NTU |
| COD (**) | 1 630 | mg/l | 112 | mg/l |

| | | |
|---|---|---|
| Color | Cloudy reddish. | Clear |
| Odor | Decomposing Organic | No smell. |
| | matter. | |

### Automotive Industry

The process for the treatment of wastewater of the present invention may also be used in the automotive industry. By way of example, and not limitation, the treatment process of the present invention effectively treats wastewater coming from the automotive industry by: eliminating and/or reducing high color content; eliminating and/or reducing suspended metals; eliminating and/or reducing dissolved metals; and attacking phosphate compounds from the use of paints and transforming them into simple compounds, among others. Each particular circumstance is analyzed on a case-by-case basis. In addition, the use of polymetallic salt mixtures propitiates a decreased consumption of coagulants and flocculants and a reduction of the acidic and alkaline agents that may be used.

### Case Seven

### Description

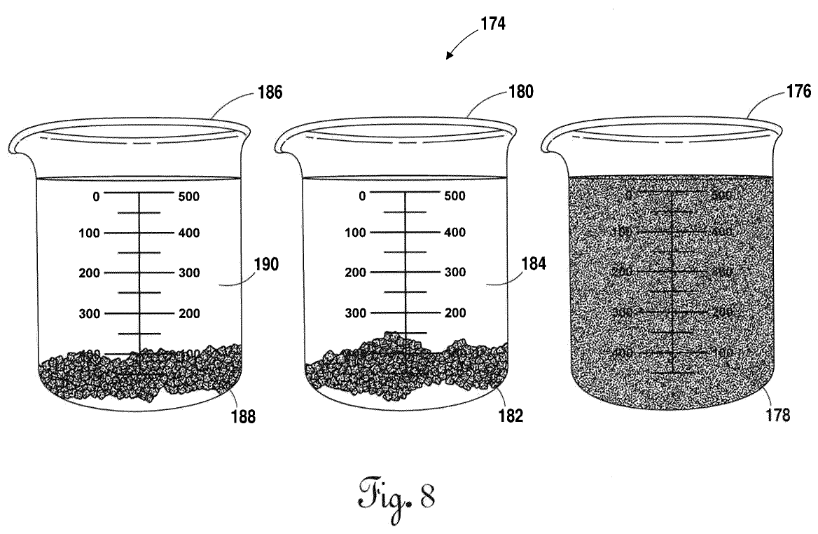

Turning now to FIG. 8, an array of samples 174 contains several containers, including containers 176, 180, 186. These containers show the treatment process in various stages. Beginning with container 176, sample 178 represented original raw water from automobile wastewater before the application of the PMSM technology and had a turbid black coloration. A simple treatment with PMSM was performed on sample 178, as shown in FIG. 8. The treatment process and results are similar to the treatment process and results described in the prior cases. After the treatment, solids 182 precipitated out of solution, leaving clear layer 184 in container 180. Solids 182 concentrated to and reduced in size to solids 188, as shown in container 186, leaving clear layer 190, ready to be separated from solids 188.

In order to establish a comparison, the values of a traditional treatment without the use of polymetallic salt mixtures were also included.

### Chemicals Used.

Coagulant B, PMSM and Flocculant A were used. Coagulant C is polyaluminum chloride. Flocculant A is an anionic polymer. The results are as shown in the following table:

### Results

TABLE 7
Parameters

| | | Traditional | | | |
|---|---|---|---|---|---|
| | | treatment | | PMSM | |
| Parameter | Entrance | (without PMSM) | | Output | |
| pH | 6.5 | 7.3 | | 8.16 | |
| TSS | 280 mg/L | 30 | mg/L | 0 | mg/L |
| COD | 960 mg/L | 261 | mg/L | 24 | mg/L |
| Nitrogen | 105 mg/L | 35 | mg/L | 3 | mg/L |

### Mining

The mining process generates a large amount of water with elevated levels of metals, heavy metals, suspended solids, and emulsified solids. Water processing may be adapted to the treatment method of the present invention or may be constructed with the treatment method of the present invention already in place.

Low-cost, low-energy, small-scale plants can be treated using the treatment method of the present invention by removing contaminants from the water and reconditioning the water for reuse in the mine. The treatment with PMSM provides elimination of heavy metals Acid mine drainage and cyanide waste may also be treated. The treatment with PMSM further provides elimination of zinc, sulphates and reduction of sodium and hardness, among others.

### Case Eight

### Description.

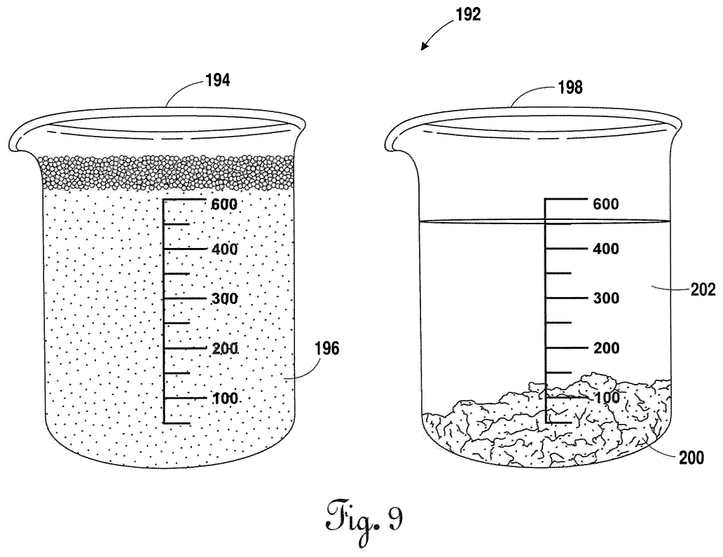

Turning now to FIG. 9, an array of samples 192 contains several containers, including containers 194 and 198. These containers show the treatment process in various stages. Beginning with container 194, sample 196 represented original raw water from mining wastewater before the application of the PMSM technology of the present invention and had a turbid white coloration. A simple treatment with PMSM was performed on the sample, as shown in FIG. 9. The treatment process and results are similar to the treatment process and results described in the prior cases. After the treatment, solids 200 precipitated out of solution, leaving clear layer 202 in container 200, ready to be separated from solids 200.

### Chemicals Used.

PMSM, Coagulant B, Coagulant C and Flocculant A were used. Coagulant B is a calcium hydroxide water blend. Coagulant C is polyaluminum chloride. Flocculant A is an anionic polymer. The results were as shown in the following table:

### Results

TABLE 8
Parameters

| | | |
|---|---|---|
| Parameter | Entrance | PMSM Output |

| | | |
|---|---|---|
| pH | 9.82 | 8.41 |

| | | | | |
|---|---|---|---|---|
| Conductivity | 27590 | uS/cm | 14740 | uS/cm |
| Zn | 501 | mg/L | 1 | mg/L |
| SO4 | 18425 | mg/L | 6526 | mg/L |
| Mg | 2254 | mg/L | 992 | mg/L |
| Na | 5516 | mg/L | 99 | mg/L |
| NH3 | 1240.11 | mg/L | 607.90 | mg/L |

| | | |
|---|---|---|
| Color | Milky White cloudy | Clear |

### Paper Industry

The process for the treatment of wastewater of the present invention may also be used in the paper industry. By way of example, and not limitation, the treatment process of the present invention effectively treats wastewater coming from the paper industry by: removing and/or reducing COD and BOD content; removing and/or reducing total suspended solids and turbidity; reducing nitrogen content; reducing color and odor, among others. In addition, the use of the present invention treats the following contaminants: bisphenols, boron, stickies, carbonates, starches, and fibers, among others. Each particular circumstance is analyzed on a case-by-case basis.

Textile industry

The process for the treatment of wastewater of the present invention may also be used in the textile industry. By way of example, and not limitation, the treatment process of the present invention effectively treats wastewater coming from the textile industry by: removing and/or reducing COD; removing and/or reducing dyes such as indigo blue. Up to 90% of dyes are removed with single treatment. Each particular circumstance is analyzed on a case-by-case basis.

### Water Polluted With Chromium (VI)

Chromium (VI) is very well known as a carcinogen. The presence of chromium (VI) in water is highly regulated and sanctioned in discharge.

Chromium (VI) removal is a process that employs different technologies, most of which are based on chromium (III) reduction.

With PMSM, however, chromium (VI) removal is achieved using equipment such as sand and carbon filters, a situation that cannot be achieved with any other technology.

The various embodiments described herein may be used singularly or in conjunction with other similar devices. The present disclosure includes preferred or illustrative embodiments of specifically described apparatuses, assemblies, and systems. Alternative embodiments of such apparatuses, assemblies, and systems can be used in conducting the invention as described herein. Other aspects and advantages of the present invention may be obtained from a study of this disclosure and the drawings.

I claim:

1. A method for municipal and industrial wastewater treatment, said method comprising the steps of:
receiving wastewater to be treated from a wastewater source into a reaction tank;
dosing said wastewater received with reagents within said reaction tank;
agitating said wastewater received and said reagents within said reaction tank for a predetermined period of time;
first transferring said wastewater received and said reagents from said reaction tank to a precipitation tank;
separating precipitates formed from said wastewater;
second transferring said wastewater from said precipitation tank into a sedimentation tank; and
storing said treated wastewater in a storage tank.

2. The method for municipal and industrial wastewater treatment, as recited in claim 1, wherein said reagents are polymetallic salt mixtures alone or in conjunction with coagulating and/or flocculant agents and/or other chemical agents for the separation of both organic and inorganic pollutants present in said wastewater.

3. The method for municipal and industrial wastewater treatment, as recited in claim 2, further comprising the additional step of clarifying said wastewater prior to said second transferring step.

4. The method for municipal and industrial wastewater treatment, as recited in claim 3, wherein, prior to said storing step, said method further comprises the step of filtering said wastewater within said sedimentation tank, said filtering step enhanced by the use of said polymetallic salt mixtures. The filtration stage may or may not be required depending on the desired output specifications.

5. The method for municipal and industrial wastewater treatment, as recited in claim 4, wherein said method is effective for suspended solids, salts, and dissolved and undissolved gases.

6. The method for municipal and industrial wastewater treatment, as recited in claim 5, wherein said agitating step further comprises transforming complex and/or organic compounds into simpler compounds.

7. The method for municipal and industrial wastewater treatment, as recited in claim 6, wherein said agitating step further comprises degrading said complex and/or organic compounds.

8. The method for municipal and industrial wastewater treatment, as recited in claim 7, wherein said agitating step further comprises precipitating heavy metals into the form of inactive salts.

9. The method for municipal and industrial wastewater treatment, as recited in claim 8, wherein said receiving, dosing, agitating, first transferring, and separating steps remove and/or reduce 80% of pollutants within a range of 0.1 to 10 hours, preferably 1 to 10 minutes.

10. The method for municipal and industrial wastewater treatment, as recited in claim 8, wherein said receiving, dosing, agitating, first transferring, and separating steps remove and/or reduce 80% of pollutants within a range of 1 to 10 minutes.

11. A composition for use in the treatment of wastewater, comprising:
a polymetallic salt mixture having the formula of: 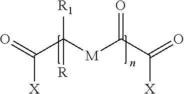
wherein n corresponds to a value between 2 and 50, M may be from the family of alkaline earth metals, transition metals or post-transition metals, R may be families of carboxyl groups, and R₁ may be families of alkenes.
